(19) United States
(12) Patent Application Publication
(10) Pub. No.: US 2011/0083818 A1
(43) Pub. Date: Apr. 14, 2011

(54) ROMAN BLIND SAFETY RELEASE MECHANISM

(76) Inventor: David M. Cross, Westport, CT (US)

(21) Appl. No.: 12/902,189

(22) Filed: Oct. 12, 2010

Related U.S. Application Data
(60) Provisional application No. 61/250,087, filed on Oct. 9, 2009.

(51) Int. Cl. F16G 11/10; A47H 5/02

(52) U.S. Cl. 160/331; 160/340; 24/115 F

(57) ABSTRACT

The present invention relates to a novel release mechanism for Roman Blinds or similar window treatments, whereby a cord release comprising a lift ball releasably attached to a spring release allow for effective operation of a Roman Blind or similar window treatment under normal operation, but allow release of a lift cord from the hem rail and through lift cord guides in the event that a child becomes entangled therein, or in the event that a user wishes to remove the shade material from the head rail.

### PRIORITY

The present application claims priority to U.S. Provisional Patent Application Ser. No. 61/250,087 to David Cross, titled “Roman Blind Safety Release Mechanism”, the contents of which are incorporated herein by reference.

### BACKGROUND

The present invention relates to a safety release mechanism for Roman Shades or Blinds. Roman Shades or Blinds are a popular choice in window coverings, and each are generally made of fabric in such a way that a unitary piece of fabric is hung vertically in a window opening to block incoming light. In operation, Roman Shades or Blinds are raised or lowered through the use of two or more lift cords that are attached on each side of the bottom of the shade or hem bar, with the lift cord running along the back of the Roman Shades or Blinds and through guide rings or openings in the fabric itself, and up to or through the head rail of the Roman Shades or Blinds.

As noted above, the cords are attached at or near the bottom of the shade or hem bar, and are guided through the rings or cord guides to the top of the Roman Shade head rail and back through a pulley system or catch system such that when the cord is pulled by a user, the attachment point on the cord guides is pulled upward, thereby allowing the shade to be raised from the bottom up. As the lift cords are urged upward through pulling on the pull cord or operating the clutch mechanism, the shade or hem bar encounters each guide or ring, the fabric overlaps such that the fabric pleasantly cascades over the last folded portion.

While the lift cord mechanism for Roman Shades or Blinds results in a highly functional and aesthetically pleasing shade, the design of Roman Shades or Blinds can result in possible safety hazards to young children through the forming of cord loops in the lift cords, and the point of connection between the bottom of the shade or hem bar presents a point where a child may be trapped between the cord and the shade. While this risk is significantly mitigated by the use of a passive restraint system, such as a quality clutch mechanism or a motorized lift system, that prevents the lift cords from being pulled back through the headrail, thereby making it extremely difficult for a child to form a loop, clutch mechanisms and/or motorization options can be an expensive option so having an inexpensive device, such as is proposed here, would be a benefit, particularly for individuals with lower incomes. As such, a functional lift cord release device that would reduce entanglement in the lift cord or in the Roman Blinds or Shades by children would be appreciated.

Additionally, the development of a device that can be easily and intuitively put back together after separation, (whether intentional or accidental) is desirable for consumers. The use of a lift ball, as opposed to a geometrically shaped catch, means that it is fairly obvious to an end user how to reattach the mechanism after the lift ball has been separated from the spring release.

Additionally, a lift cord release that would be operable to allow removal of the Roman Shades from the head rail or other hardware systems for maintenance, repair, or cleaning would be greatly appreciated. However, present releases such as those disclosed in U.S. Pat. No. 7,302,738 to Nien et al, do not allow for the simple removal of a cord release, as the release mechanisms are often larger than any rings through which the lift cord passes. Conversely, those releases that would allow the lift cord to retreat through each guide or ring allow the lift cord to be pulled entirely through the lift mechanism or clutch in the head rail, often resulting in an extended repair job that requires the disassembly of the head rail, or a nonfunctional unit. As such, a lift cord release that reduces the likelihood of child entanglement and allows disassembly of the Roman Shade or Blind without the requirement of restringing the lift mechanism would be greatly appreciated.

### BRIEF DESCRIPTION OF THE DRAWINGS

FIG. 1 is a rear plan view of a Roman Blind having a cord release according to one embodiment.

FIG. 1A is an enlarged view of a cord release on the Roman Blind of FIG. 1 according to at least one embodiment of the present application.

FIG. 2 is a rear plan view of a Roman Blind having a cord release according to at least one embodiment, and where the lift ball has been released from a spring release.

FIG. 2A is an enlarged view of a lift ball traveling through the cord guides of the Roman Blind of FIG. 2 according to at least one embodiment of the present application.

FIG. 3 is a side cross-section view of a lift ball according to at least one embodiment.

FIG. 4 is a top plan view of a lift ball according to at least one embodiment.

FIG. 5 is a side plan view of a cord release according to at least one embodiment, showing a lift ball within a spring release.

FIG. 6 is a side plan view of a cord release according to at least one embodiment, showing a lift ball pulled out of the spring release.

FIG. 7 is a side plan view of a spring clip according to at least one embodiment.

### DESCRIPTION

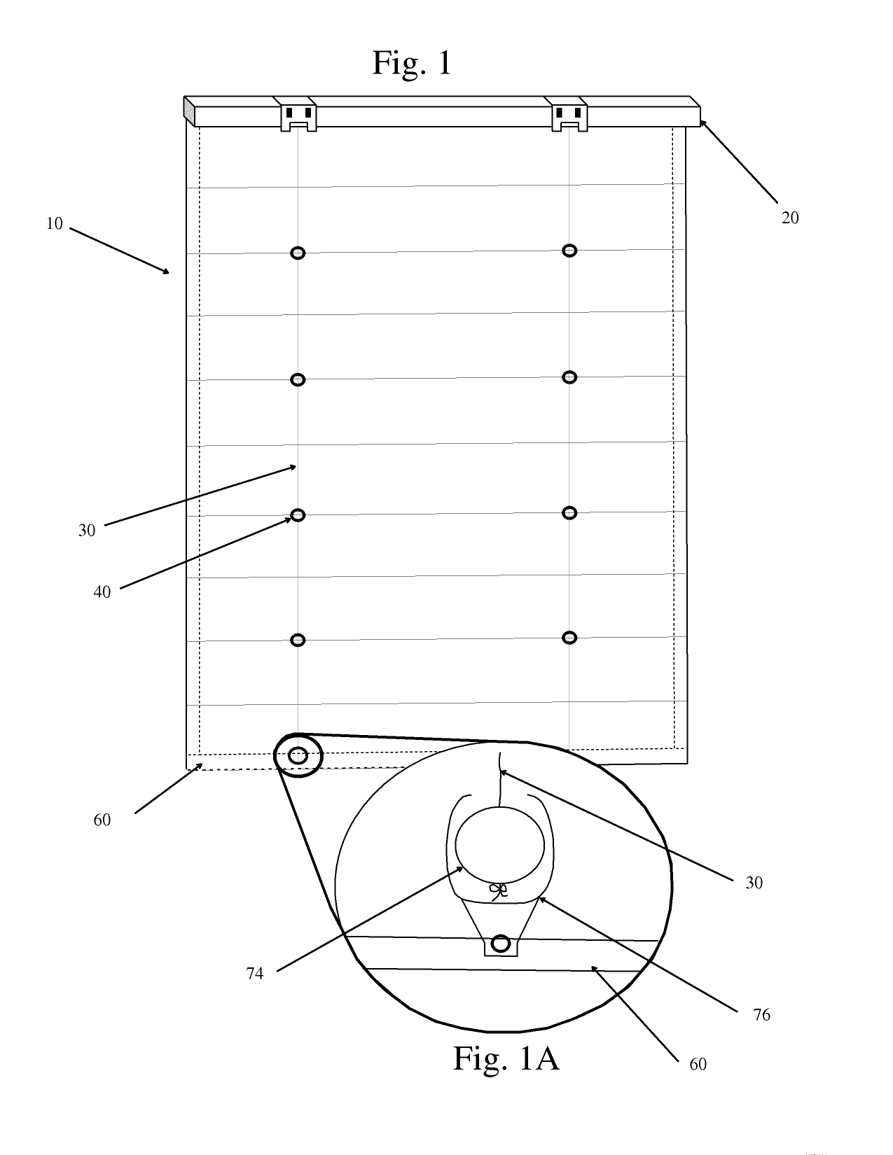

Turning now to FIG. 1, according to at least one embodiment, a Roman Blind 10 incorporating a lift release is shown from the perspective of the back side of Roman Blind 10. According to at least one embodiment, Roman Blind 10 comprises head rail 20, through which lift cords 30 are routed and controlled through conventional pull mechanisms or clutch mechanisms known in the art (not shown). Optionally, a clutch mechanism using a gear reduction unit as known in the art may be utilized to reduce the amount of vertical movement of Roman Blind 10 per each actuation by a user. Additionally, lift cords 30 are routed through cord guides 40 attached to shade material 50 at predetermined intervals via attachment means 100 or other means, with lift cords 30 ultimately attaching to Roman Blind 10 at hem rail 60 through cord release 70. As shown in FIG. 1A, cord release 70 comprises lift ball 74 to which lift cord 30 is attached, and spring retainer 76, which is attached to hem rail 60 or other suitable portion of shade material 50.

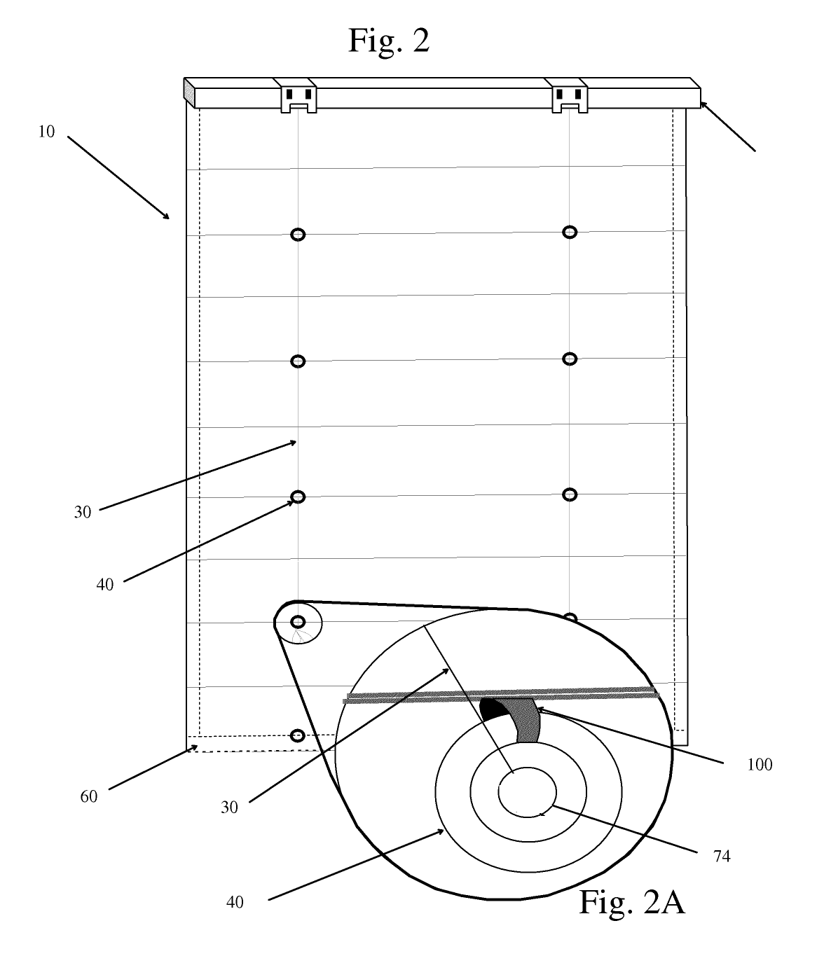

It will be appreciated that according to at least one exemplary embodiment, and as shown in FIG. 2A, lift ball 74 is sized to be smaller than the interior diameter of cord guides 40, thereby allowing lift ball to be freely pulled through cord guides 40 when lift ball 74 is not releasably attached to spring retainer 76. Conversely, according to at least one exemplary embodiment, the overall size of cord release 70 when lift ball 74 is attached to spring retainer 76 as shown in FIG. 1A, the overall size of cord release 70 is greater than the interior diameter of cord guides 40, thereby precluding cord release 70 from traveling through cord guides 40 when lift ball 74 is attached to spring retainer 76. Functionally, such a sizing allows lift cords 30 to urge cord release upward when a user engages the lifting mechanism, thereby allowing the cord to travel upward, pulling the hem rail 60 upward and likewise gathering up shade material 50 in a cascading effect as each cord guide is pulled upward as it is encountered by cord release 70 and/or hem rail 60. As an optional embodiment, it will be appreciated that cord release 70 may be sized to be smaller than the interior diameter of cord guides 40 without adversely affecting the function of the cord lifting action. For example, since spring retainer 76 is attached to hem rail 60 or any other suitable portion of shade material 50, it will be appreciated that cord guides 40 cannot pass over hem rail 60 or any other suitable portion of shade material 50 as lift cords 30 are being urged upward toward head rail 20.

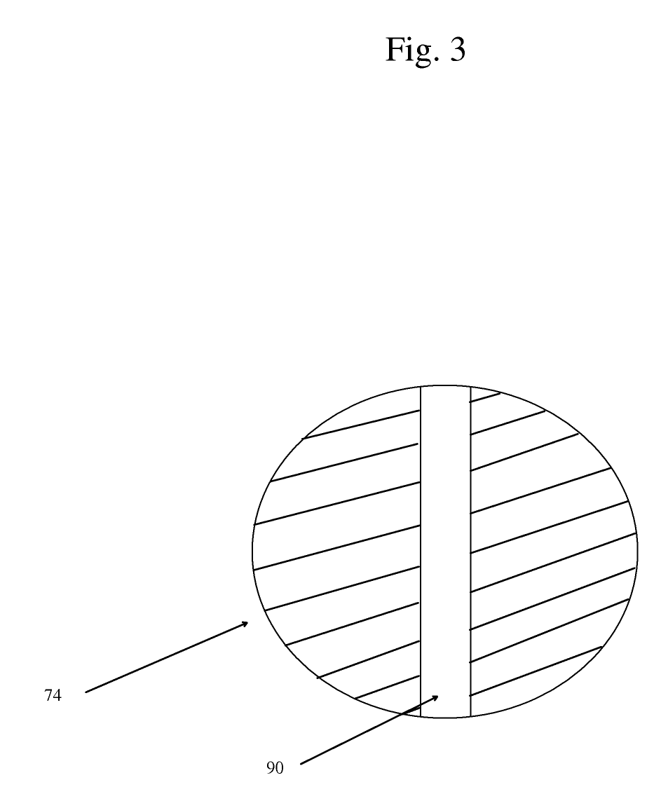

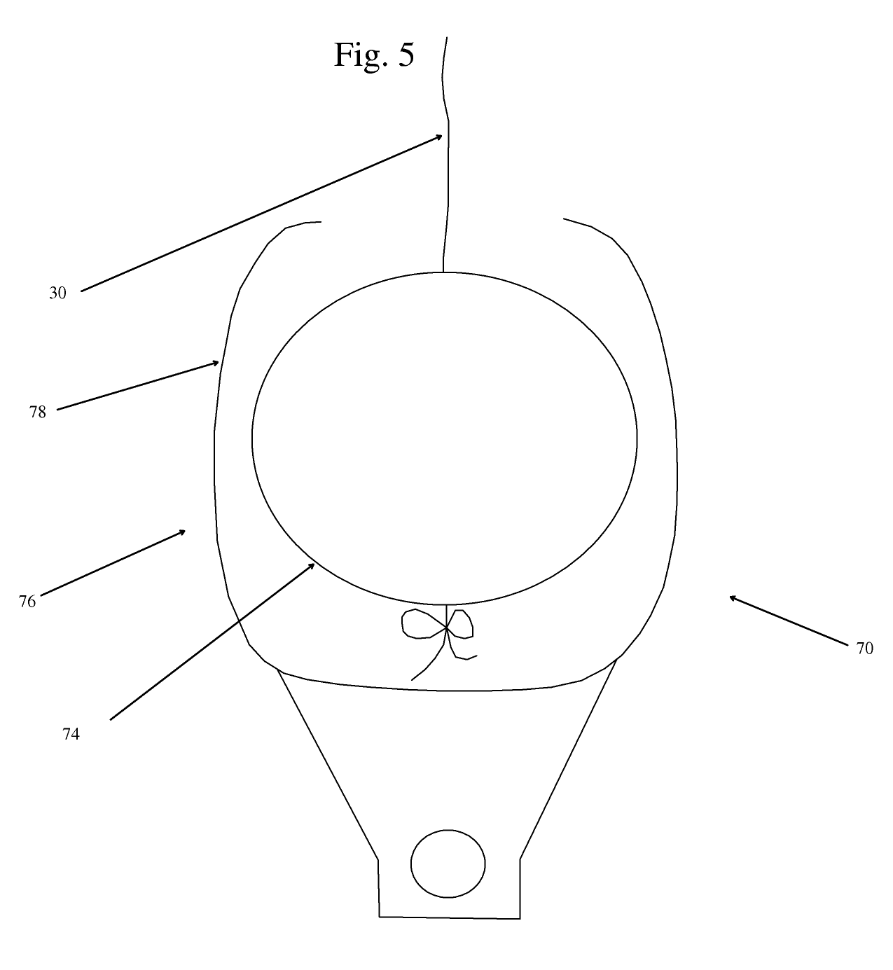

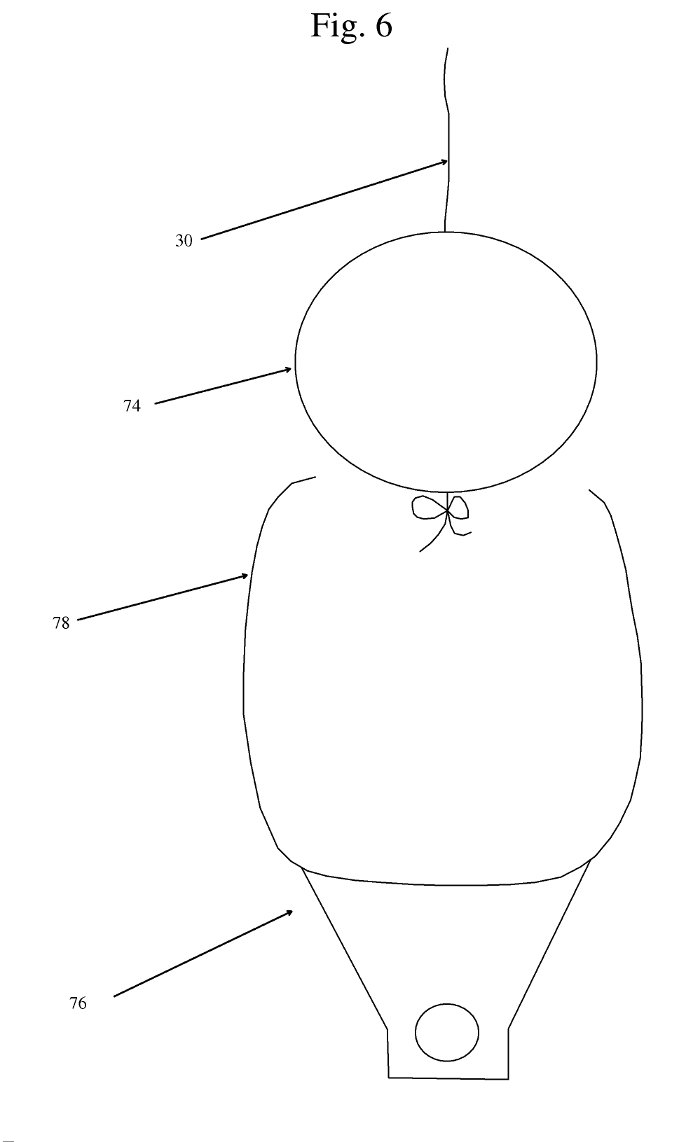

Turning now to FIGS. 3, 4, and 5, according to at least one embodiment, lift ball 74 is a substantially cylindrical or spherical ball sized to be larger than an opening defined by spring arms 80 of spring retainer 76. As such, because spring arms 80 optionally comprise a material operable to be urged apart when an amount of force greater than a preselected amount is applied outwardly and/or upwardly against spring arms 80, lift ball 74 is operable to be inserted within spring retainer 76 even though the diameter of lift ball is designed to be larger than the opening defined by spring arms 80. Further, it will be appreciated that spring arms 80 and/or spring retainer 76 are optionally comprised of a resilient material, thereby allowing lift ball 74 to enter within the opening defined by spring arms 80 to be releasably inserted to spring retainer 76. For example, spring arms 80 and/or spring retainer 76 may comprise a spring steel, steel, resilient plastic, or other material operable to allow lift ball 74 to be releasably inserted within spring retainer 76. Likewise, it will be appreciated that the force necessary to insert and/or remove lift ball 74 from within spring retainer may be adjusted by varying the thickness of spring arms 80, the material from which spring arms 80 or spring retainer 76, by varying the opening defined by spring arms 80, or by varying the diameter of lift ball 74. By changing these variables, the force required to release lift ball 74 from spring retainer 76 can be altered to ensure that the pulling force required to separate lift cord 30 from hem rail 60 is low enough to release the two elements prior to causing a choke hazard, but that the force is sufficient to maintain the elements together under average working conditions for Roman Blind 10.

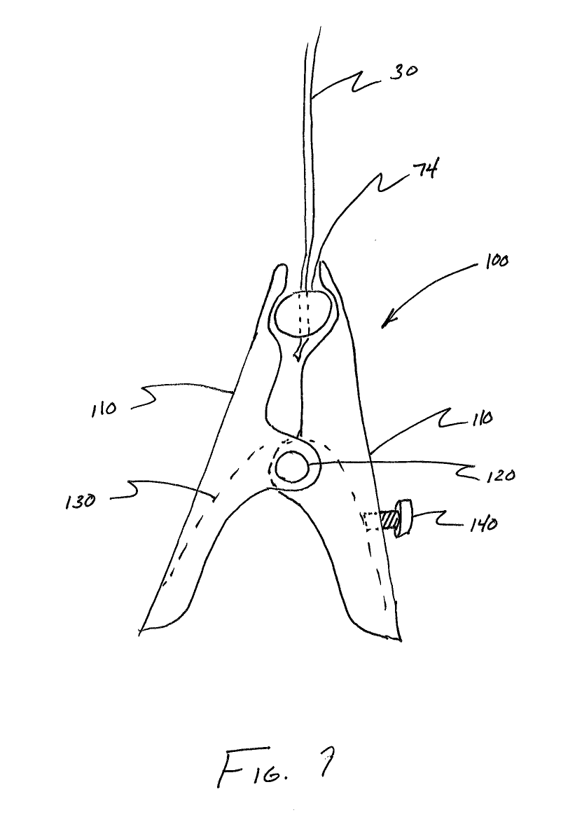

Additionally a spring clip (a.k.a. “Alligator Clip”) may be used. By using an inner spring controlling the release force needed to pull the lift ball 74 from the spring retainer 76 may be easier to control in manufacturing. Turning now to FIG. 7, a spring clip 100 is shown as an alternative embodiment of a spring retainer 76. In practice, a spring clip 100 includes clip arms 110, a pivot hinge 120, spring 130, and, optionally, a tension adjustment mechanism 140. In operation, lift ball 74 is retained between clip arms 110, and spring 130 urges clip arms toward lift ball 74 to retain lift ball 74 within spring clip 100 unless sufficient force to lift cord 30 pulls lift ball 74 from spring clip 100. In operation, spring 130 may be sized and shaped to adjust the force required to release lift ball 74 from spring clip 100. Alternatively, a tension adjustment mechanism 140 may be utilized to allow a user to adjust the spring tension applied to spring clip 100 such that as tension adjustment mechanism may be turned in one direction to compress spring 130 and thereby increase the tension, or turned in the opposite direction to release compressive forces on spring 130, and thereby decrease the tension and therefore the amount of force necessary to remove lift ball 74 from spring clip 100.

Furthermore, in the manufacturing of a releasable spring clip 100 it should be appreciated that different springs 130 may be utilized, with different characteristics, such as spring wire thickness or the numbers of turns in the spring to adjust the release tension of spring clip 100 to the desired level.

It will be appreciated that placing a lift ball 74 back into releasable spring clip 100 is facilitated by squeezing the lower portion of clip arms 110, thereby facilitating an easier return of lift ball 74 to spring clip 100 after it has been released, or during the process of manufacturing the shade when the lift cords have to be adjusted in order to ensure all lift cords are tied off at the same length so that the blind raised evenly. This improved ease of removal and replacement is further useful to the end consumer who may wish to remove the shade for cleaning.

It will be appreciated that the total force required to pull lift ball 74 from spring retainer 76 should vary depending upon the total weight of hem rail 60 and shade material 50, as well as the total number of lift cords 30 utilized in the particular shade design. According to at least one embodiment, the total force required to pull lift ball 74 from spring retainer 76 is no more than about 5 lbs. more than the total weight of the hem rail 60 divided by the total number of lift cords 30; is no more than about 4 lbs. more than the total weight of the hem rail 60 divided by the total number of lift cords 30; is no more than about 3 lbs. more than the total weight of the hem rail 60 divided by the total number of lift cords 30; is no more than about 2 lbs. more than the total weight of the hem rail 60 divided by the total number of lift cords 30; or is no more than about 1.5 lbs. more than the total weight of the hem rail 60 divided by the total number of lift cords 30.

According to at least one embodiment, the total force required to pull lift ball 74 from spring retainer 76 may be calculated by the amount of force required to pull a single lift cord 30 at approximately 90 degrees to the shade material 50 to form a loop. According to at least one embodiment, the total force required to pull lift ball 74 from spring retainer 76 is no more than about 5 lbs. of force exerted on a single lift cord 30 at approximately 90 degrees to the shade material 50 to form a loop; is no more than about 4 lbs. of force exerted on a single lift cord 30 at approximately 90 degrees to the shade material 50 to form a loop; is no more than about 3 lbs. of force exerted on a single lift cord 30 at approximately 90 degrees to the shade material 50 to form a loop; is no more than about 2 lbs. of force exerted on a single lift cord 30 at approximately 90 degrees to the shade material 50 to form a loop; or is no more than about 1.5 lbs. of force exerted on a single lift cord 30 at approximately 90 degrees to the shade material 50 to form a loop.

According to at least one embodiment, lift ball 74 is a substantially cylindrical or spherical ball sized to be smaller than cord guides 40 to allow lift ball 74 to pass through cord guides in the event that lift ball 74 is released from spring retainer 76. As shown in FIG. 2A, cord guides 40 is optionally be a ring-shaped structure attached to shade material 50, or cord guides 40 may be another looped cord or openings within shade material 50 that allow lift ball 74 to be passed through shade material 50. In at least one exemplary embodiment, lift ball 74 is sized to have a diameter of at least 0.01″ smaller than the inside diameter of cord guides 40. According to at least one additional embodiment, lift ball 74 is sized to have a diameter of at least 0.125″ smaller than the inside diameter of cord guides 40. According to at least one additional embodiment, lift ball 74 is sized to have a diameter of at least 0.25″ smaller than the inside diameter of cord guides 40.

According to at least one embodiment, lift ball 74 is sized larger than any openings within head rail 20, thereby preventing retraction of attached lift cord 30 within head rail 20. According to at least one embodiment, ball 74 is sized to have a diameter of at least 0.01″ larger than the largest opening in head rail 20.

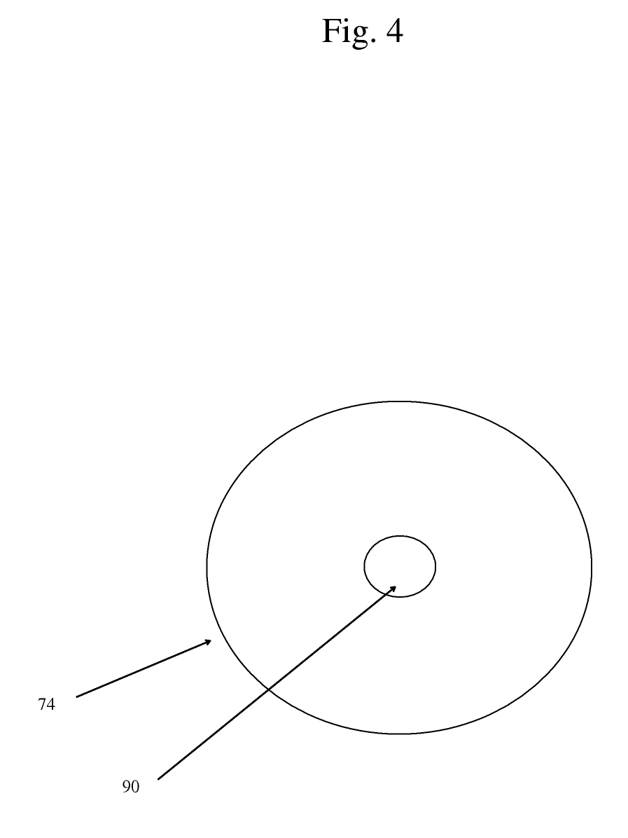

Turning now to FIGS. 3 and 4, a side cross section and top plan view of at least one embodiment of lift ball 74 is provided. As shown therein, lift ball 74 is substantially spherical, and includes at least one hollow channel 90 whereby at least one lift cord 30 is operable to pass therethrough. It will be appreciated that hollow channel 90 is optionally sized such that after passing the at least one lift cord 30 through hollow channel 90, the at least one lift cord 30 may be tied into a knot such that the knot cannot pass through hollow channel 90. Such a method of construction allows assembly of Roman Blind 10 to be more easily accomplished, as often lift cords 30 must be adjusted at the factory or upon purchase to ensure that lift cords 30 are of an appropriate length to ensure that hem rail 60 hangs horizontally and is retracted at the same rate when operated. Allowing adjustment through tying one or more knots in one or more lift cords 30 allows for a substantially easier adjustment of how hem rail 60 hangs.

In at least one other embodiment, lift ball 74 may comprise a spring-loaded stop that substantially pinches the one or more lift cords 30 within hollow channel 90, similar to those stops available under the ORB brand name and available from RollEase, Inc.

### Example

According to at least one exemplary embodiment, a chart for calculating the force to release a lift ball 74 from spring retainer 76 is provided. It will be appreciated that utilizing a release weight low enough to prevent potential strangulation or entanglement while still maintaining an operable blind may be difficult, particularly when a typical pull cord blind is utilized. A relatively low release weight plays against the desire for lift ball 74 not to accidentally separate from spring release 76 during normal operation. As such, Table 1 below establishes a calculation format easily utilized by manufacturers of roman blinds to calculate the minimum number of lift cords 30 lift to be utilized when manufacturing a blind so that the weight needed to lift the blind is no more than 1.5 pounds on average per lift cord. To utilize the calculation format shown below, a manufacturer supplies: the weight in grams per meter or ounces per square yards of the fabric (or fabrics, in the case of a lined shade) used, the weight of the “battens” or cross bars used (if any), the number of cross bars used in a given length of a shade and the weight of the hem rail 60.

As an example, Table 1A shows a size grid and the weight of a shade in each size (exclusive of the headrail or pulley mechanism) for roman shades with cross bars (or battens) in sizes up to 144″ (width)×150″ (length) using a typical fabric that weighs 9 ounces per square yard, a fiberglass hem rail 60 that weighs 1.6 oz per linear foot and battens (or cross bars) that weigh 0.6 oz per linear foot and are spaced about 9″ apart. From this weight chart, a manufacturer can deduce how many lift lines to use so that the weight per lift line is no more than 1.5 pounds, as shown in Table 1B, which can optionally be used in conjunction with Table 1A. This type of calculation can be easily done by someone who is relatively versed in the program “Excel,” and can modify the chart or calculation to ensure that each lift cord has a proper release weight while maintaining sufficient overall force to allow operation of the shade. Moreover, as Table 1 shows, lift lines do not have to be spaced more closely than 12″ apart, which is reasonable for manufacturers of roman shades.

TABLE 1A
Weight of a roman blind (in pounds) using:

| | | | | | | | | | | |
|---|---|---|---|---|---|---|---|---|---|---|
| Shade fabric | 9 | oz/sq | | | | | | | | |
| weighting | | yard | | | | | | | | |
| Battens | 0.6 | oz per | | | | | | | | |
| Weighing | | foot | | | | | | | | |
| Hem rail | 1.6 | oz per | | | | | | | | |
| weighing | | foot | | | | | | | | |
| Hem rail Weight | 4.80 | 6.40 | 8.00 | 9.60 | 11.20 | 12.80 | 14.40 | 16.00 | 17.60 | 19.20 |
| (Ounces) | | | | | | | | | | |
| Weight per | 1.80 | 2.40 | 3.00 | 3.60 | 4.20 | 4.80 | 5.40 | 6.00 | 6.60 | 7.20 |
| batten | | | | | | | | | | |
| (Ounces) | | | | | | | | | | |

| | Width of Shade in Inches | | | | | | | | | | Battens |
|---|---|---|---|---|---|---|---|---|---|---|---|
| Length in Inches | 36 | 48 | 60 | 72 | 84 | 96 | 108 | 120 | 132 | 144 | (9″ avg.) |
| 36 | 1.20 | 1.60 | 2.00 | 2.40 | 2.80 | 3.20 | 3.60 | 4.00 | 4.40 | 4.80 | 3 |
| 42 | 1.41 | 1.88 | 2.34 | 2.81 | 3.28 | 3.75 | 4.22 | 4.69 | 5.16 | 5.63 | 4 |
| 48 | 1.61 | 2.15 | 2.69 | 3.23 | 3.76 | 4.30 | 4.84 | 5.38 | 5.91 | 6.45 | 5 |
| 54 | 1.71 | 2.28 | 2.84 | 3.41 | 3.98 | 4.55 | 5.12 | 5.69 | 6.26 | 6.83 | 5 |
| 60 | 1.91 | 2.55 | 3.19 | 3.83 | 4.46 | 5.10 | 5.74 | 6.38 | 7.01 | 7.65 | 6 |
| 66 | 2.12 | 2.83 | 3.53 | 4.24 | 4.94 | 5.65 | 6.36 | 7.06 | 7.77 | 8.48 | 7 |
| 72 | 2.33 | 3.10 | 3.88 | 4.65 | 5.43 | 6.20 | 6.98 | 7.75 | 8.53 | 9.30 | 8 |
| 78 | 2.42 | 3.23 | 4.03 | 4.84 | 5.64 | 6.45 | 7.26 | 8.06 | 8.87 | 9.68 | 8 |
| 84 | 2.63 | 3.50 | 4.38 | 5.25 | 6.13 | 7.00 | 7.88 | 8.75 | 9.63 | 10.50 | 9 |
| 90 | 2.83 | 3.78 | 4.72 | 5.66 | 6.61 | 7.55 | 8.49 | 9.44 | 10.38 | 11.33 | 10 |
| 96 | 3.04 | 4.05 | 5.06 | 6.08 | 7.09 | 8.10 | 9.11 | 10.13 | 11.14 | 12.15 | 11 |
| 102 | 3.13 | 4.18 | 5.22 | 6.26 | 7.31 | 8.35 | 9.39 | 10.44 | 11.48 | 12.53 | 11 |
| 108 | 3.34 | 4.45 | 5.56 | 6.68 | 7.79 | 8.90 | 10.01 | 11.13 | 12.24 | 13.35 | 12 |
| 114 | 3.54 | 4.73 | 5.91 | 7.09 | 8.27 | 9.45 | 10.63 | 11.81 | 12.99 | 14.18 | 13 |
| 120 | 3.75 | 5.00 | 6.25 | 7.50 | 8.75 | 10.00 | 11.25 | 12.50 | 13.75 | 15.00 | 14 |
| 126 | 3.96 | 5.28 | 6.59 | 7.91 | 9.23 | 10.55 | 11.87 | 13.19 | 14.51 | 15.83 | 15 |
| 132 | 4.05 | 5.40 | 6.75 | 8.10 | 9.45 | 10.80 | 12.15 | 13.50 | 14.85 | 16.20 | 15 |
| 138 | 4.26 | 5.68 | 7.09 | 8.51 | 9.93 | 11.35 | 12.77 | 14.19 | 15.61 | 17.03 | 16 |
| 144 | 4.46 | 5.95 | 7.44 | 8.93 | 10.41 | 11.90 | 13.39 | 14.88 | 16.36 | 17.85 | 17 |
| 150 | 4.56 | 6.08 | 7.59 | 9.11 | 10.63 | 12.15 | 13.67 | 15.19 | 16.71 | 18.23 | 17 |

TABLE 1B

| Minimum | | | | | | | | | | |
|---|---|---|---|---|---|---|---|---|---|---|
| Number of Lift | | | | | | | | | | |
| Cords to be | | | | | | | | | | |
| Used to keep | | | | | | | | | | |
| weight per lift | | | | | | | | | | |
| cord below 1.5 | | | | | | | | | | |
| pounds per lift | | | | | | | | | | |
| cord | 36 | 48 | 60 | 72 | 84 | 96 | 108 | 120 | 132 | 144 |
| 36 | 1 | 1 | 1 | 2 | 2 | 2 | 2 | 3 | 3 | 3 |
| 42 | 1 | 1 | 2 | 2 | 2 | 3 | 3 | 3 | 3 | 4 |
| 48 | 1 | 1 | 2 | 2 | 3 | 3 | 3 | 4 | 4 | 4 |
| 54 | 1 | 2 | 2 | 2 | 3 | 3 | 3 | 4 | 4 | 5 |
| 60 | 1 | 2 | 2 | 3 | 3 | 3 | 4 | 4 | 5 | 5 |
| 66 | 1 | 2 | 2 | 3 | 3 | 4 | 4 | 5 | 5 | 6 |
| 72 | 2 | 2 | 3 | 3 | 4 | 4 | 5 | 5 | 6 | 6 |
| 78 | 2 | 2 | 3 | 3 | 4 | 4 | 5 | 5 | 6 | 6 |
| 84 | 2 | 2 | 3 | 4 | 4 | 5 | 5 | 6 | 6 | 7 |
| 90 | 2 | 3 | 3 | 4 | 4 | 5 | 6 | 6 | 7 | 8 |
| 96 | 2 | 3 | 3 | 4 | 5 | 5 | 6 | 7 | 7 | 8 |
| 102 | 2 | 3 | 3 | 4 | 5 | 6 | 6 | 7 | 8 | 8 |
| 108 | 2 | 3 | 4 | 4 | 5 | 6 | 7 | 7 | 8 | 9 |
| 114 | 2 | 3 | 4 | 5 | 6 | 6 | 7 | 8 | 9 | 9 |
| 120 | 3 | 3 | 4 | 5 | 6 | 7 | 8 | 8 | 9 | 10 |
| 126 | 3 | 4 | 4 | 5 | 6 | 7 | 8 | 9 | 10 | 11 |
| 132 | 3 | 4 | 5 | 5 | 6 | 7 | 8 | 9 | 10 | 11 |
| 138 | 3 | 4 | 5 | 6 | 7 | 8 | 9 | 9 | 10 | 11 |
| 144 | 3 | 4 | 5 | 6 | 7 | 8 | 9 | 10 | 11 | 12 |
| 150 | 3 | 4 | 5 | 6 | 7 | 8 | 9 | 10 | 11 | 12 |

To further ensure that lift ball 74 does not accidentally separate from the spring release during operation, manufacturers of roman shades may optionally utilize a clutch mechanism with a gear reduction as the means of lifting the shade. A clutch mechanism with a gear reduction system, such as is commercially available from RollEase of Stamford Conn. or Coulisse of the Netherlands prevents end user from “jerking” the blind up quickly, thereby reducing the chance of accidental separation of lift ball 74 from spring release 76 during normal operation.

It will further be appreciated a lift ball 74 and spring release 76 may be sold in a kit form to retrofit existing roman shades to allow them to break away. For example, lift ball 74 may be included with spring release 76, with spring release 76 including a hole in its base operable to receive a screw or other fastener such that spring release 76 is attached to hem rail 60. Additionally, cord guides 40 may be included such that cord guides 40 that are sized to allow lift ball to travel through them upon release, may be included, along with a means for attaching cord guides 40 to existing roman blind 10. As such, through the sale of these elements in a unitary package, existing roman blinds 10 may be retrofitted into a safer or more convenient product.

While specific embodiments have been disclosed herein, combinations of those embodiments, as well as certain variations thereof are included in the scope of this application.

What is claimed is:

1. A window treatment apparatus comprising:
a. a head rail having a lift cord stop apparatus, and having at least one lift cord passing through the lift cord stop apparatus;
b. shade material attached to the head rail and extending in a downward direction and ending in a hem rail, the shade material having a plurality of cord guides attached thereto and arranged in a vertical manner such that the at least one lift cord may pass from the lift cord stop apparatus downward through an internal diameter of each of a plurality of cord guides;
c. at least one lift ball removably attached to the at least one lift cord, the at least one lift ball sized such that a largest outer diameter of the lift ball is smaller than the internal diameter of each of the plurality of cord guides;
d. at least one spring retainer operable to releasably engage the at least one lift ball, the at least one spring retainer attached to the hem rail; and whereby the lift ball is operable to be pulled from the spring retainer when a predetermined force is applied to the hem rail or lift cord.

2. The window treatment apparatus of claim 1, wherein the predetermined force is approximately 1.5 or more pounds more than a total weight of the hem rail and the shade material.

3. The window treatment apparatus of claim 1, wherein the predetermined force is approximately 2.0 or more pounds more than a total weight of the hem rail and the shade material.

4. The window treatment apparatus of claim 1, wherein the predetermined force is approximately 3.0 or more pounds more than a total weight of the hem rail and the shade material.

5. The window treatment apparatus of claim 1, wherein the head rail further comprises at least one head rail opening through which the at least one lift cord passes, whereby the at least one head rail opening is sized to be smaller than the largest outer diameter of the lift ball.

6. The window treatment apparatus of claim 1, wherein the head rail stop mechanism comprises a pulley mechanism disposed within the head rail.

7. The window treatment apparatus of claim 1, wherein the head rail stop mechanism comprises a clutch mechanism disposed within the head rail.

8. The window treatment apparatus of claim 1, wherein the headrail stop mechanism comprises a cordless or spring operated system (as is currently sold by Leovlor, Hunter Douglas and others) disposed within the headrail.

9. The window treatment apparatus of claim 1, wherein the head rail stop mechanism comprises a motorized system (such as is currently sold by Somfy, Lutron and others) disposed within the head rail.

10. The window treatment apparatus of claim 1, wherein the at least one spring retainer further comprises a first and second spring arm defining an opening smaller than the largest outer diameter of the lift ball.

11. The window treatment apparatus of claim 8, wherein the first and second spring arms comprise a resilient material operable to be urged apart from one another such that the lift ball may be releasably held within the defined opening between them.

12. The window treatment apparatus of claim 8, wherein the first and second spring arms are controlled by a separate spring (e.g. Alligator Clip) and are operable to be urged apart from one another such that the lift ball may be releasably held within the defined opening between them.

13. The window treatment apparatus of claim 1, wherein the resilient material is selected from a group consisting of metal, plastic, and rubber.

14. A window treatment apparatus comprising:
a. a head rail having a shade material attached thereto, the shade material extending in a downward direction and ending in a hem rail, the shade material having a plurality of cord guides attached thereto and arranged in a vertical manner;
b. at least one lift cord passing through the head rail and through an inside diameter of the plurality of cord guides,
c. at least one lift ball removably attached to the at least one lift cord, the at least one lift ball sized such that a largest outer diameter of the lift ball is smaller than the inside diameter of each of the plurality of cord guides;
d. at least one spring retainer attached to the hem rail, the at least one spring retainer operable to releasably engage the at least one lift ball.

15. The window treatment apparatus of claim 10, wherein the lift ball is operable to disengage from the at least one spring retainer when a predetermined force is applied to either the hem rail or the at least one lift cord.

16. The window treatment apparatus of claim 11, wherein the predetermined force is more than a total weight of the hem rail and the shade material.

17. The window treatment apparatus of claim 13, wherein the largest outer diameter of the lift ball is at least 0.01″ smaller than the inside diameter of each of the plurality of cord guides.

18. The window treatment apparatus of claim 14, wherein the at least one spring retainer further comprises a first and second spring arm defining an opening smaller than the largest outer diameter of the lift ball.

19. The window treatment apparatus of claim 15, wherein the first and second spring arms comprise a resilient material operable to be urged apart from one another such that the lift ball may be releasably held within the defined opening between them.

20. The window treatment apparatus of claim 1, wherein the head rail further comprises at least one head rail opening through which the at least one lift cord passes, whereby the at least one head rail opening is sized to be smaller than the largest outer diameter of the lift ball.
